(19) United States
(12) Patent Application Publication
(10) Pub. No.: US 2012/0319514 A1
(43) Pub. Date: Dec. 20, 2012

(54) VEHICLE DRIVING APPARATUS

(75) Inventors: Mikio Iwase, Anjyo (JP); Tomohide Suzuki, Kariya (JP); Naoya Jinnai, Anjo (JP); Tatsuya Okishima, Chiryu (JP); Toshihiko Kamiya, Toyota (JP)

(73) Assignees: TOYOTA JIDOSHA KABUSHIKI KAISHA, Toyota-shi, Aichi-ken (JP); AISIN AW CO., LTD., Anjo-shi, Aichi-ken (JP)

(21) Appl. No.: 13/522,651

(22) PCT Filed: Mar. 4, 2011
(86) PCT No.: PCT/JP2011/055721

§ 371 Date: Jul. 17, 2012

(30) Foreign Application Priority Data
Mar. 5, 2010 (JP) 2010-049192
Mar. 5, 2010 (JP) 2010-049193
Nov. 2, 2010 (JP) 2010-246511

(51) Int. Cl. H02K 7/108

(52) U.S. Cl. 310/78; 903/915

(57) ABSTRACT

A vehicle driving apparatus includes a rotating electrical machine serving as a drive power source of the vehicle and a rotation sensor that detects a rotation position of a rotor of the rotating electrical machine. The rotating electrical machine includes a rotor support that supports the rotor from a radial direction inner side, and includes a cylindrical support that extends in an axial direction. The support includes a first tubular portion and a second tubular portion, an inner and an outer peripheral surface of the second tubular portion both having a smaller diameter than an inner and an outer peripheral surface of the first tubular portion. A support bearing that supports the rotor support rotatably is disposed to contact the inner peripheral surface of the first tubular portion, and a sensor rotor of the rotation sensor is disposed to contact the outer peripheral surface of the second tubular portion.

### INCORPORATION BY REFERENCE

The disclosure of Japanese Patent Applications No. 2010-246511 filed on Nov. 2, 2010, No. 2010-049192 filed on Mar. 5, 2010, and No. 2010-049193 filed on Mar. 5, 2010, including the specification, drawings and abstract is incorporated herein by reference in its entirety.

### BACKGROUND OF THE INVENTION

The present invention relates to a vehicle driving apparatus including a rotating electrical machine serving as a drive power source of a vehicle and a rotation sensor for detecting a rotation position of a rotor of the rotating electrical machine.

### Description of the Related Art

An apparatus described in Japanese Patent Application Publication No. JP-A-2009-101730 below, for example, is already known as a vehicle driving apparatus of the type described above. As shown in FIG. 2 and so on of Japanese Patent Application Publication No. JP-A-2009-101730, in this vehicle driving apparatus, a rotor supporting member (RS) that supports a rotor main body (a large number of laminated plates m4 in Japanese Patent Application Publication No. JP-A-2009-101730; likewise hereafter) from a radial direction inner side includes a supporting cylindrical portion that is formed in a cylindrical shape so as to extend in an axial direction and disposed coaxially with a rotary axis of a rotor (a rotor m1). The supporting cylindrical portion is formed in an intermediate position of a region that is occupied in the radial direction by the rotor supporting member, and a support bearing (a first rotary bearing B1) that supports the rotor supporting member to be capable of rotating is disposed in contact with an inner peripheral surface of the supporting cylindrical portion. As a result, the rotor of the rotating electrical machine can be supported to be capable of rotating appropriately. Further, a sensor rotor (a resolver/rotor Rr) of a rotation sensor (a resolver R) is disposed in contact with an outer peripheral surface of the supporting cylindrical portion.

Further, in a vehicle driving apparatus described in Japanese Patent Publication No. 3080612 below, for example, a fixed fastening portion that fastens a rotor supporting member (a hub portion of a rotor 8 in Japanese Patent Publication No. 3080612; likewise hereafter) and a power transmission member (a pump impeller 5 of a torque converter) to each other fixedly using a bolt (a bolt 4) is provided in a connecting portion between the rotor supporting member and the power transmission member. It is understood from this constitution that a tool insertion hole is provided in a support wall (a wall portion of a casing 10) adjacent to a rotating electrical machine (an electric machine) in an axial direction, and therefore, to couple the rotor supporting member and the power transmission member, the bolt is operated using a tool inserted into the tool insertion hole in the axial direction.

The apparatus of Japanese Patent Publication No. 3080612 is not provided with a rotation sensor, but it is possible to apply the constitution described in Japanese Patent Application Publication No. JP-A-2009101730 to the constitution of Japanese Patent Publication No. 3080612. In the apparatus of Japanese Patent Application Publication No. JP-A-2009-101730, however, the sensor rotor is disposed on a radial direction outer side of the support bearing, and therefore an outer diameter of the rotation sensor is likely to increase. To achieve a reduction in an overall apparatus size, it is typically desirable to dispose the rotation sensor compactly. In a vehicle driving apparatus constituted such that a tool is inserted in the axial direction into a tool insertion hole provided in a support wall, as in the apparatus of Japanese Patent Publication No. 3080612, measures must be taken to ensure that the rotation sensor does not interfere with the tool when the tool is inserted, and therefore compact disposal of the rotation sensor is particularly desirable.

### SUMMARY OF THE INVENTION

Hence, demand exists for the realization of a vehicle driving apparatus in which a rotor of a rotating electrical machine can be supported to be capable of rotating appropriately and a rotation sensor can be disposed compactly.

A vehicle driving apparatus according to a first aspect of the present invention includes: a rotating electrical machine that serves as a drive power source of a vehicle, and a rotation sensor that detects a rotation position of a rotor of the rotating electrical machine. In the vehicle driving apparatus, the rotating electrical machine includes a rotor supporting member that supports the rotor from a radial direction inner side, the rotor supporting member includes a cylindrical supporting cylindrical portion that extends in an axial direction, the supporting cylindrical portion includes a first tubular portion and a second tubular portion, an inner peripheral surface and an outer peripheral surface of the second tubular portion both having a smaller diameter than an inner peripheral surface and an outer peripheral surface of the first tubular portion, and a support bearing that supports the rotor supporting member rotatably is disposed to contact the inner peripheral surface of the first tubular portion, and a sensor rotor of the rotation sensor is disposed to contact the outer peripheral surface of the second tubular portion.

Note that the term “rotating electrical machine” is used as a concept including a motor (electric motor), a generator (electric generator), and a motor/generator that functions as both a motor and a generator as necessary.

According to the first aspect, the support bearing is disposed to contact the inner peripheral surface of the first tubular portion, which is formed such that both the inner peripheral surface and the outer peripheral surface thereof have a larger diameter than those of the second tubular portion, and therefore the rotor supporting member can be supported to be capable of rotating appropriately with a high degree of precision using the comparatively large support bearing. Further, the sensor rotor of the rotation sensor is disposed to contact the outer peripheral surface of the second tubular portion, which is formed such that both the inner peripheral surface and the outer peripheral surface thereof have a smaller diameter than those of the first tubular portion, and therefore the sensor rotor, and accordingly the rotation sensor, can be reduced in diameter. As a result, the entire rotation sensor can be disposed compactly.

Hence, a vehicle driving apparatus in which a rotor of a rotating electrical machine can be supported to be capable of rotating appropriately and a rotation sensor can be disposed compactly can be realized.

The vehicle driving apparatus according to a second aspect of the present invention may further include: a power transmission member that transmits a power of the rotating electrical machine to a vehicle wheel side; and a support wall that extends at least in the radial direction on an opposite side of the rotation sensor in the axial direction to the rotor supporting member. In the vehicle driving apparatus, a fixed fastening portion that fastens the rotor supporting member and the power transmission member to each other fixedly using a bolt may be provided in a connecting portion between the rotor supporting member and the power transmission member, at least one tool insertion hole into which a tool for operating the bolt can be inserted may be provided in a radial direction position of the support wall corresponding to the fixed fastening portion, and a sensor stator of the rotation sensor may be provided so as to avoid the tool insertion hole when fixed to the support wall.

According to the second aspect, the power transmission member can be fastened fixedly to the rotor supporting member appropriately using the bolt. At this time, at least one tool insertion hole is provided in the radial direction position of the support wall corresponding to the fixed fastening portion, and therefore the bolt can be tightened and loosened by inserting a tool through the tool insertion hole with respect to the fixed fastening portion between the rotor supporting member and the power transmission member, which is disposed adjacent to the support wall in the axial direction. Hence, assembly and maintenance can be performed on the apparatus easily. Further, the sensor stator is provided so as to avoid the tool insertion hole when fixed to the support wall, and therefore the bolt can be operated appropriately while avoiding interference with the sensor stator even when the rotation sensor is disposed between the support wall, and the rotor supporting member and power transmission member.

The vehicle drive apparatus according to a third aspect of the present invention may further include one or both of an engagement device that selectively drive-couples an internal combustion engine serving as a drive power source of the vehicle and the rotating electrical machine to each other and a fluid coupling capable of transmitting a drive power via an internally charged fluid. In the vehicle drive apparatus, the power transmission member for transmitting the power of the rotating electrical machine to the vehicle wheel side may be constituted by an engagement rotary member serving as a rotary member included in the engagement device, a joint rotary member serving as a rotary member included in the fluid coupling, or the integrally coupled engagement rotary member and joint rotary member, and the rotation sensor may be disposed on an opposite side of the rotor supporting member to the power transmission member in the axial direction.

Note that the term “drive-coupled” indicates a state in which two rotary elements are coupled to be capable of transmitting drive power, and is used as a concept including a state where the two rotary elements are coupled to rotate integrally or a state where the two rotary elements are coupled to be capable of transmitting drive power via one or more transmission members, These transmission members include various members for transmitting rotation at an identical speed or a shifted speed, such as a shaft, a gear mechanism, a belt, and a chain. Further, an engagement device that transmits rotation and drive power selectively, for example, a friction clutch or a mesh clutch, may be used as the transmission member.

Furthermore, the term “fluid coupling” is used as a concept including both a torque converter having a torque amplification function and a normal fluid coupling not having a torque amplification function.

According to the third aspect, the vehicle can be caused to travel by transmitting at least the power of the rotating electrical machine to the vehicle wheel side via the power transmission member constituted by the engagement rotary member included in the engagement device, the joint rotary member included in the fluid coupling, or the integrally coupled engagement rotary member and joint rotary member. At this time, the power transmission member is disposed on the opposite side of the rotor supporting member to the rotation sensor in the axial direction, and therefore the rotation sensor, the rotor supporting member, and the power transmission member can be arranged in series in the axial direction and disposed compactly as a whole. Thus, a reduction can be achieved in the overall size of the apparatus.

### BRIEF DESCRIPTION OF THE DRAWINGS

FIG. 1 is a pattern diagram showing a schematic constitution of a driving apparatus according to an embodiment;

FIG. 2 is a partial sectional view of the driving apparatus;

FIG. 3 is a partially enlarged view of FIG. 2;

FIG. 4 is a sectional view of main parts of the driving apparatus; and

FIG. 5 is a view showing a relationship between a tool insertion hole, a first bolt, and a rotation sensor.

### DETAILED DESCRIPTION OF THE EMBODIMENTS

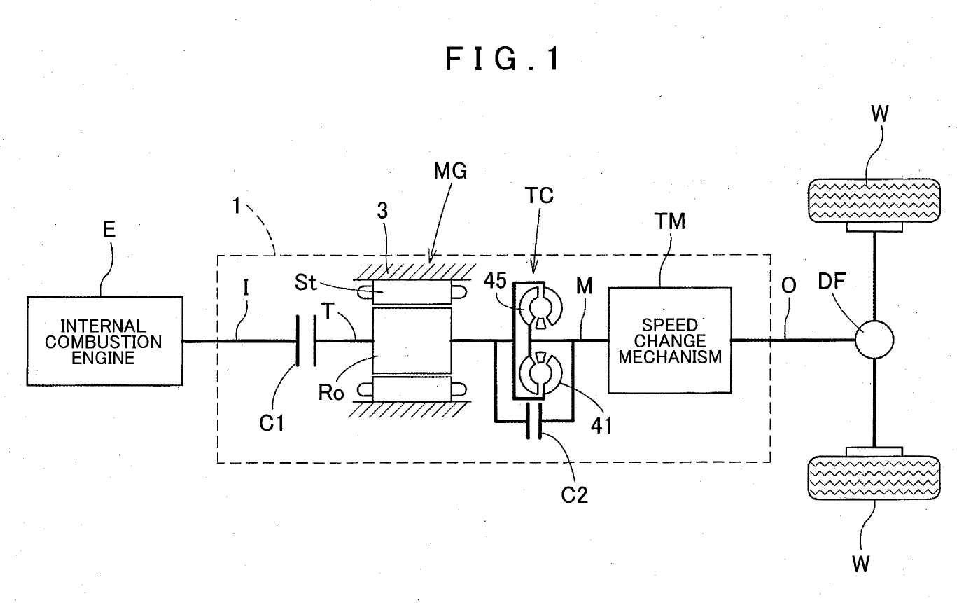

An embodiment of the present invention will now be described with reference to the drawings. FIG. 1 is a pattern diagram showing a schematic constitution of a driving apparatus 1 according to this embodiment. The driving apparatus 1 is a driving apparatus (a hybrid driving apparatus) for a hybrid vehicle that uses one or both of an internal combustion engine E and a rotating electrical machine MG as a vehicle drive power source. The driving apparatus 1 is constituted by a so-called one motor parallel type hybrid vehicle driving apparatus. The driving apparatus 1 according to this embodiment will be described in detail below.

### 1. Overall Constitution of Driving Apparatus

First, the overall constitution of the driving apparatus 1 according to this embodiment will be described. As shown in FIG. 1, the driving apparatus 1 includes an input shaft 1 drive-coupled to the internal combustion engine E, which serves as a first drive power source of the vehicle, an output shaft O drive-coupled to a vehicle wheel W, and the rotating electrical machine MG, which serves as a second drive power source of the vehicle. The driving apparatus 1 also includes an input clutch C1, a torque converter TC, and a speed change mechanism TM. The input clutch C1, the rotating electrical machine MG, the torque converter TC, and the speed change mechanism TM are disposed on a power transmission path linking the input shaft I to the output shaft O in order from the input shaft I side. Further, each of these constitutions, with the exception of a part of the input shaft I and a part of the output O, is housed in a case (a driving apparatus case) 3.

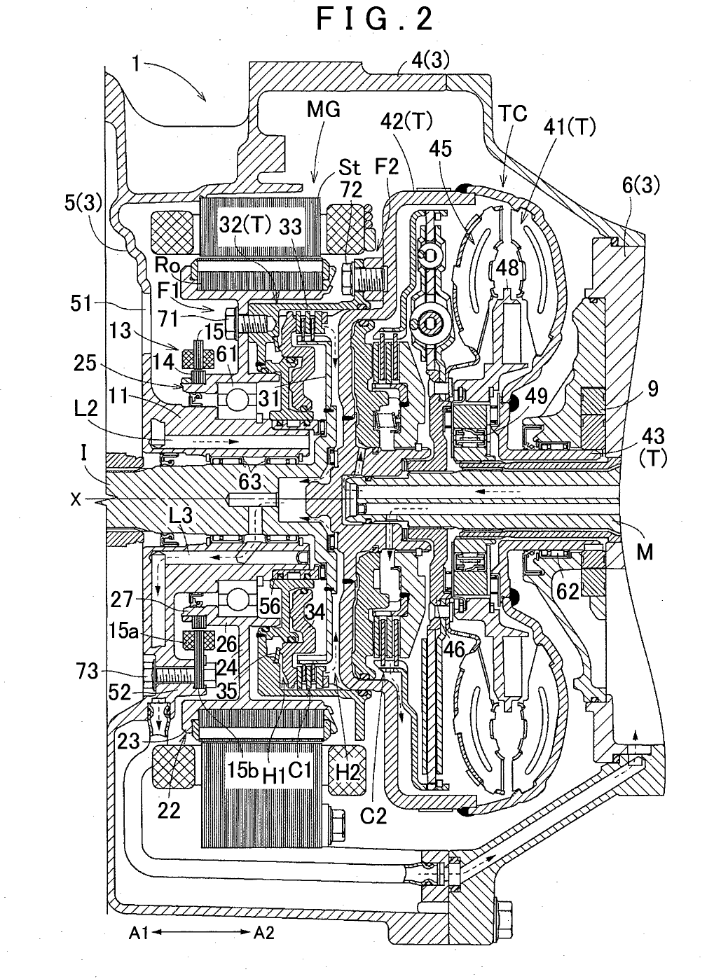

Note that in this embodiment, the input shaft I, rotating electrical machine MG, torque converter TC, and output shaft O are all disposed on a axis center X (see FIG. 2), and therefore the driving apparatus 1 according to this embodiment has a uniaxial constitution, which is suitable for a case in which the apparatus is installed in an FR (front-engine, rear-wheel drive) type vehicle. Further, an “axial direction”, a “radial direction”, and a “circumferential direction” are defined in the following description using the axis center X as a reference in the absence of further differentiation. Moreover, as regards description of the axial direction when focusing on a specific site of the driving apparatus 1, a direction heading toward the internal combustion engine E side (the left side in FIG. 2), i.e. extending to one side in the axial direction, will be referred to as an “axial first direction A1”, and a direction heading toward the output shaft O side (the right side in FIG. 2), i.e. extending to the other side in the axial direction, will be referred to as an “axial second direction A2”.

The internal combustion engine E generates power when driven by burning fuel inside an engine, and various well-known engines, such as a gasoline engine or a diesel engine, for example, may be employed. In this example, an output rotary shaft such as a crankshaft of the internal combustion engine E is drive-coupled to the input shaft I via a damper device (not shown). Further, the input shaft I is drive-coupled to the rotating electrical machine MG via the input clutch C1. When the input clutch C1 is in an engaged state, the internal combustion engine E and the rotating electrical machine MG are drive-coupled via the input shaft I so as to rotate integrally, and when the input clutch C1 is in a disengaged state, the internal combustion engine E and the rotating electrical machine MG are disconnected. In other words, the input clutch C1 selectively drive-couples the internal combustion engine E and the rotating electrical machine MG. In this embodiment, the input clutch C1 corresponds to an “engagement device” of the present invention.

The rotating electrical machine MG is constituted by a stator St and a rotor Ro, and is capable of functioning as a motor that generates motive power upon reception of a supply of electric power and a generator that generates electric power upon reception of a supply of motive power. For this purpose, the rotating electrical machine MG is electrically connected to a storage device (not shown). In this example, a battery is used as the storage device. Note that a capacitor or the like may also be used favorably as the storage device. The rotating electrical machine MG performs power running upon reception of a supply of electric power from the battery or supplies electric power generated using torque (drive power) output by the internal combustion engine E or an inertial force of the vehicle to the battery for storage therein. The rotor Ro of the rotating electrical machine MG is drive-coupled to a pump impeller 41 of the torque converter TC via a power transmission member T.

The torque converter TC is a device for converting the torque of one or both of the internal combustion engine E and the rotating electrical machine MG and transmitting the converted torque to an intermediate shaft M. The torque converter TC includes the pump impeller 41, which is drive-coupled to the rotor Ro of the rotating electrical machine MG via the power transmission member T, a turbine runner 45 drive-coupled to the intermediate shaft M so as to rotate integrally therewith, and a stator 48 (see FIG. 2) provided between the pump impeller 41 and the turbine runner 45. The torque converter TC is capable of performing torque transmission between the pump impeller 41 and the turbine runner 45 via oil (an example of a fluid) charged into the interior thereof. When a rotation speed difference occurs between the pump impeller 41 and the turbine runner 45 at this time, torque converted in accordance with a rotation speed ratio is transmitted. In this embodiment, the torque converter TC corresponds to a “fluid coupling”.

The torque converter TC also includes a lockup clutch C2. The lockup clutch C2 selectively drive-couples the pump impeller 41 and the turbine runner 45. When the lockup clutch C2 is in an engaged state, the torque converter TC transmits the torque of one or both of the internal combustion engine E and the rotating electrical machine MG to the intermediate shaft M as is, i.e. without passing through the oil in the interior. The intermediate shaft M serves as an input shaft (a shift input shaft) of the speed change mechanism TM.

The speed change mechanism TM is a device for shifting a rotation speed of the intermediate shaft M at a predetermined speed ratio and transmitting the shifted rotation to the output shaft O. In this embodiment, an automatic stepped speed change mechanism capable of switching between a plurality of shift speeds having different speed ratios is used as the speed change mechanism TM. Note that an automatic continuously variable speed change mechanism capable of modifying the speed ratio continuously, a manual stepped speed change mechanism capable of switching between a plurality of shift speeds having different speed ratios, and so on may also be used as the speed change mechanism TM. The speed change mechanism TM shifts the rotation speed of the intermediate shaft M at a predetermined speed ratio set at each point in time and performs torque conversion, and then transmits the shifted rotation and the converted torque to the output shaft O. The rotation and torque transmitted to the output shaft O are distributed to two vehicle wheels W on a left side and a right side via an output differential gear device DF. As a result, the torque of one or both of the internal combustion engine E and the rotating electrical machine MG is transmitted to the vehicle wheels W, and the driving apparatus 1 is thus capable of causing the vehicle to travel.

### 2. Constitutions of Respective Parts of Driving Apparatus

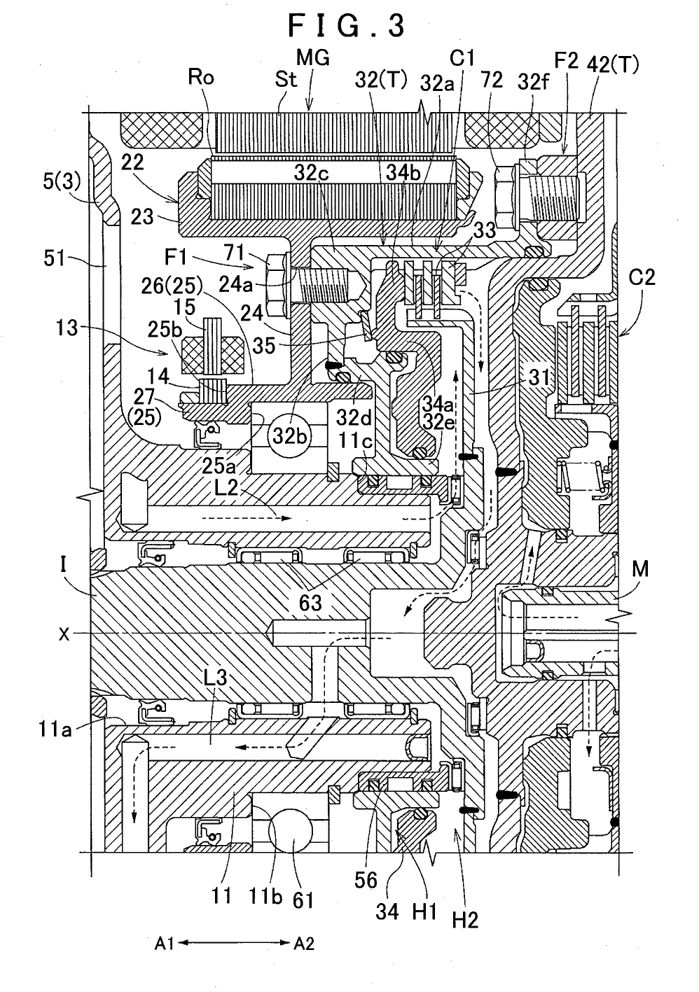

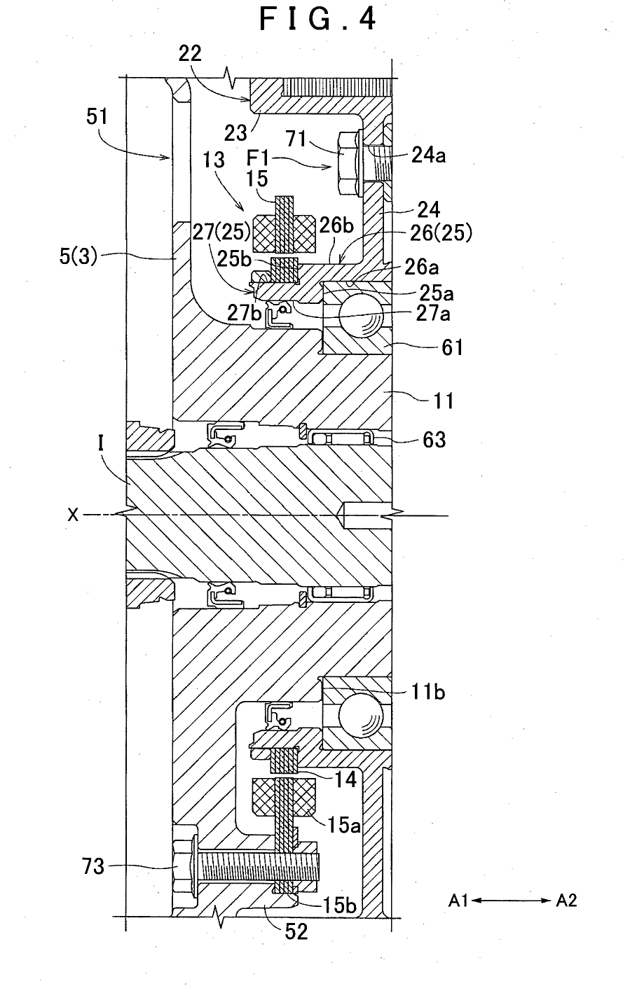

Next, the constitutions of the respective parts of the driving apparatus 1 according to this embodiment will be described with reference to FIGS. 2 and 3. Note that FIG. 3 is a partially enlarged view of the sectional view shown in FIG. 2. Further, FIG. 4 is an enlarged view of the main parts of FIG. 2.
2-1. Case

As shown in FIG. 2, the case 3 is formed in a substantially cylindrical shape. In this embodiment, the case 3 includes a peripheral wall 4 that has a substantially cylindrical shape and covers a radial direction outer side of the rotating electrical machine MG, the input clutch C1, the torque converter TC, and so on, an end portion support wall 5 that covers an axial first direction A1 side of the rotating electrical machine MG and the input clutch C1, and an intermediate support wall 6 that covers an axial second direction A2 side of the torque converter TC. The rotating electrical machine MG the input clutch C1, and the torque converter TC are housed in an internal space of the case 3 between the end portion support wall 5 and the intermediate support wall 6. Further, although not shown in the drawings, the speed change mechanism TM is housed in a space on the axial second direction A2 side of the intermediate support wall 6.

The end portion support wall 5 is shaped to extend at least in the radial direction, and here is constituted by a substantially disc-shaped wall portion extending in the radial direction and the circumferential direction. In this embodiment, the end portion support wall 5 corresponds to a “support wall” of the present invention. A tubular projecting portion 11 is provided in a radial direction central portion of the end portion support wall 5. The tubular projecting portion 11 is a cylindrical projecting portion disposed coaxially with the axis center X and formed to project from the end portion support wall 5 toward the axial second direction A2 side. The tubular projecting portion 11 is formed integrally with the end portion support wall 5. An axial direction length of the tubular projecting portion 11 is greater than an axial direction length of the rotor Ro. An axial center through hole 11a (see FIG. 3 and so on) penetrating in the axial direction is formed in a radial direction central portion of the tubular projecting portion 11. The input shaft I is inserted into the axial center through hole 11a. Thus, the input shaft I is disposed to penetrate to a radial direction inner side of the tubular projecting portion 11 and inserted into the case 3 through the end portion support wall 5.

In this embodiment, as shown partially in FIG. 3, a first oil passage (not shown), a second oil passage L2, and a third oil passage L3 are formed in the tubular projecting portion 11. The first oil passage is an oil supply passage for supplying oil to a working oil pressure chamber H1, to be described below, of the input clutch C1. The second oil passage L2 is an oil supply passage for supplying oil to a circulation oil pressure chamber H2, to be described below, of the input clutch C1. The third oil passage L3 is an oil discharge passage for returning oil discharged from the circulation oil pressure chamber H2 to an oil pan (not shown).

The intermediate support wall 6 is shaped to extend at least in the radial direction, and here is constituted by a substantially disc-shaped wall portion extending in the radial direction and the circumferential direction. In this embodiment, the intermediate support wall 6 is formed as a separate member to the peripheral wall 4 and fastened fixedly to a step portion formed on an inner peripheral surface of the peripheral wall 4 by a fastening member such as a bolt. An oil pump 9 is provided on the intermediate support wall 6. A pump rotor of the oil pump 9 is drive-coupled to the pump impeller 41 via a pump drive shaft 43 so as to rotate integrally therewith. As the pump impeller 41 rotates, the oil pump 9 discharges oil, thereby generating oil pressure for supplying the oil to the respective parts of the driving apparatus 1.
2-2. Rotating Electrical Machine

As shown in FIG. 2, the rotating electrical machine MG is disposed on the axial second direction A2 side of the end portion support wall 5 and on the axial first direction A1 side of the torque converter TC. Further, the rotating electrical machine MG is disposed on the radial direction outer side of the input shaft I and the input clutch C1.

The rotating electrical machine MG and the input clutch C1 are disposed in positions that overlap partially when viewed from the radial direction. Note that when the phrase “overlap partially when viewed from a certain direction” is used with regard to the arrangement of two members, this means that when the certain direction is assumed to be a sight line direction and a viewpoint is shifted in respective orthogonal directions to the sight line direction, viewpoints from which the two members appear to overlap exist in at least some regions. The stator St of the rotating electrical machine MG is fixed to the case 3. The rotor Ro is disposed on the radial direction inner side of the stator St. The rotor Ro is disposed opposite the stator St via a minute gap in the radial direction, and supported by the case 3 to be capable of rotating. More specifically, a rotor supporting member 22 that supports the rotor Ro and rotates integrally with the rotor Ro is supported rotatably on the tubular projecting portion 11 of the case 3 via a first bearing 61.

As shown in FIGS. 2 and 3, the rotor supporting member 22 supports the rotor Ro of the rotating electrical machine MG from the radial direction inner side. The rotor supporting member 22 is disposed on the axial first direction A1 side of the input clutch C1. The rotor supporting member 22 is formed in a shape that extends at least in the radial direction in order to support the rotor Ro relative to the first bearing 61 disposed on the radial direction inner side of the rotor Ro. In this embodiment, the rotor supporting member 22 includes a rotor holding portion 23, a radial direction extending portion 24, and a supporting cylindrical portion 25.

The rotor holding portion 23 is a part that holds the rotor Ro. The rotor holding portion 23 is disposed coaxially with the axis center X and formed in a substantially cylindrical shape so as to contact an inner peripheral surface and both axial direction side faces of the rotor Ro. The radial direction extending portion 24 is formed integrally with the rotor holding portion 23 and formed to extend to the radial direction inner side from the vicinity of an axial direction central portion of the rotor holding portion 23. In this example, the radial direction extending portion 24 is constituted by an annular plate-shaped portion that extends in the radial direction and the circumferential direction. Further, first bolt insertion holes 24a are provided in the radial direction extending portion 24 in a plurality of circumferential direction locations (see FIG. 3). First bolts 71 for fastening the rotor supporting member 22 to a tubular connecting member 32 are inserted into the first bolt insertion holes 24a.

The supporting cylindrical portion 25 is provided integrally with a radial direction inner side end portion of the radial direction extending portion 24. The supporting cylindrical portion 25 is constituted by a cylindrical portion disposed coaxially with the axis center X and formed to extend to both axial direction sides from the radial direction extending portion 24. In this embodiment, the first bearing 61 is disposed in contact with an inner peripheral surface of the supporting cylindrical portion 25, and therefore the rotor supporting member 22 is supported by the first bearing 61 disposed between the inner peripheral surface of the supporting cylindrical portion 25 and the outer peripheral surface of the tubular projecting portion 11. As a result, the rotor supporting member 22 is supported rotatably on the outer peripheral surface of the tubular projecting portion 11 via the first bearing 61. In this embodiment, a seal member is disposed between the supporting cylindrical portion 25 and the tubular projecting portion 11 on the axial first direction A1 side of the first bearing 61. As a result, the supporting cylindrical portion 25 and the tubular projecting portion 11 are tightly sealed from each other.

Further, in this embodiment, a rotation sensor 13 for detecting a rotation position of the rotor Ro relative to the stator St in the rotating electrical machine MG is provided on an outer peripheral surface of the supporting cylindrical portion 25. The rotation sensor 13 is disposed between the end portion support wall 5 and the rotor supporting member 22 (here, mainly the radial direction extending portion 24) in the axial direction. In other words, the end portion support wall 5 is disposed on an opposite side of the rotation sensor 13 to the rotor supporting member 22 in the axial direction. Note that in this example, a resolver is used as the rotation sensor 13. The arrangement and structure of the rotation sensor 13 will be described in detail below.
2-3. Input clutch

The input clutch C1 is a frictional engagement device that selectively drive-couples the input shaft I to the rotating electrical machine MG and the torque converter TC. The input clutch C1 is constituted by a multiplate wet clutch mechanism. Further, as shown in FIG. 2, the input clutch C1 is disposed between the rotor supporting member 22 and the torque converter TC in the axial direction. Furthermore, in the radial direction, the input clutch C1 is disposed between the tubular projecting portion 11 and the rotor Ro of the rotating electrical machine MG. The tubular projecting portion 11, the input clutch C1, and the rotor Ro are disposed to overlap partially when viewed from the radial direction. The input clutch C1 includes a clutch hub 31, the tubular connecting member 32, a friction member 33, a piston 34, and the working oil pressure chamber H1.

The input clutch C1 includes an input side friction member and an output side friction member as the friction members 33. The input side friction member and the output side friction member together form a pair. Here, the input clutch C1 includes a plurality of input side friction members and a plurality of output side friction members which are disposed alternately in the axial direction. The plurality of friction members 33 are all formed in an annular plate shape and disposed between the clutch hub 31 and the tubular connecting member 32.

The clutch hub 31 is an annular plate-shaped member that extends in the radial direction so as to support the plurality of input side friction members (in this example, hub side friction members) from the radial direction inner side. The clutch hub 31 is formed to pass between the piston 34 and a cover portion 42, to be described below, of the torque converter TC in the axial direction and extend in the radial direction, and a radial direction inner side end portion of the clutch hub 31 is coupled to the input shaft I. As a result, the input shaft I and the clutch hub 31 are coupled to rotate integrally. Note that the clutch hub 31 is a member for transmitting the rotation and torque of the internal combustion engine E via the input shaft I, and serves as an input side rotary member (an engagement input side member) of the input clutch C1.

The tubular connecting member 32 is a substantially cylindrical member that is formed to cover at least a radial direction outer side of the plurality of friction members 33 and support the output side friction members (in this example, drum side friction members) from the radial direction outer side. The tubular connecting member 32 is constructed to function as a clutch drum of the input clutch C1. Further, the tubular connecting member 32 includes a part formed in an overall bowl shape so as to further cover the axial first direction A1 side of the piston 34 and the radial direction outer side of the piston 34. The tubular connecting member 32 is coupled to the rotor supporting member 22 of the rotating electrical machine MG and also to the cover portion 42. The tubular connecting member 32 serves as an output side rotary member (engagement output side member) of the input clutch C1, which forms a pair with the clutch hub 31, to transmit to the torque converter TC on the output shaft O side the rotation and torque input into the clutch hub 31 when the input clutch C1 is engaged. In this embodiment, the tubular connecting member 32 corresponds to an “engagement rotary member” of the present invention.

As shown in FIG. 3, the tubular connecting member 32 serving as the clutch drum includes an axial direction extending portion 32a, a radial direction extending portion 32b, a tubular extending portion 32d, a tubular projecting portion 32e, and a radial direction extending portion 32f. The axial direction extending portion 32a is formed in a cylindrical shape and disposed coaxially with the axis center X. The axial direction extending portion 32a is formed in a tubular shape that extends in the axial direction to cover at least the radial direction outer side of the friction members 33. The axial direction extending portion 32a contacts the radial direction extending portion 24 of the rotor supporting member 22 on the axial first direction A1 side and the cover portion 42 of the torque converter TC on the axial second direction A2 side. The cover portion 42 is fitted to the axial direction extending portion 32a so as to contact the axial direction extending portion 32a in the radial direction. The radial direction extending portion 32f is formed integrally with the axial direction extending portion 32a and formed in an annular plate shape to extend to the radial direction outer side from an axial second direction A2 side end portion of the axial direction extending portion 32a.

The radial direction extending portion 32b is formed integrally with the axial direction extending portion 32a in a substantially annular plate shape so as to extend toward the radial direction inner side from an axial first direction A1 side end portion of the axial direction extending portion 32a. The radial direction extending portion 32b is disposed on the axial first direction A1 side of the friction members 33. An attachment portion 32c is formed integrally with the axial direction extending portion 32a and the radial direction extending portion 32b in a connection site between the axial direction extending portion 32a and the radial direction extending portion 32b. The attachment portion 32c is formed as a thick portion having a predetermined thickness in the axial direction and the radial direction, and serves as a site in which the tubular connecting member 32 and the rotor supporting member 22 are attached. First bolt fastening holes in which the first bolts 71 are fastened are provided in the attachment portion 32c in a plurality of circumferential direction locations. Further, the cylindrical tubular extending portion 32d, which is formed integrally with the radial direction extending portion 32b so as to extend in the axial direction, is provided in the radial direction extending portion 32b on the radial direction inner side of the attachment portion 32c.

In other words, the radial direction extending portion 32b is shaped such that a site thereof on the radial direction inner side of the tubular extending portion 32d is offset to the axial second direction A2 side relative to a site thereof on the radial direction outer side. The tubular extending portion 32d is fitted to the supporting cylindrical portion 25 of the rotor supporting member 22 so as to contact the supporting cylindrical portion 25 in the radial direction.

The tubular projecting portion 32e is formed integrally with the radial direction extending portion 32b in a cylindrical shape so as to extend to either axial direction side from a radial direction inner side end portion of the radial direction extending portion 32b. The tubular projecting portion 32e is disposed on the radial direction inner side of the friction members 33 so as to overlap the friction members 33 partially when viewed from the radial direction. Further, the tubular projecting portion 32e is disposed on the radial direction outer side of an axial second direction A2 side end portion of the tubular projecting portion 11 of the case 3 so as to oppose the tubular projecting portion 11 in the radial direction via a predetermined gap. A sleeve 56 is disposed between the tubular projecting portion 32e and the tubular projecting portion 11 of the case 3. More specifically, the sleeve 56 is disposed to contact an inner peripheral surface of the tubular projecting portion 32e and an outer peripheral surface of the tubular projecting portion 11 of the case 3.

The piston 34, which presses the friction members 33 in a pressing direction, is disposed to be capable of sliding in the axial direction relative to an outer peripheral surface of the tubular extending portion 32d and an outer peripheral surface of the tubular projecting portion 32e. In this embodiment, the piston 34 is provided to press the friction members 33 from the axial first direction A1 side, i.e. the radial direction extending portion 32b side. Hence, in this example, the axial second direction A2 corresponds to the aforementioned “pressing direction” and the axial first direction A1 corresponds to an “anti-pressing direction”. In this embodiment, the piston 34 includes a tubular extending portion 34a that has a tubular shape and is formed in a predetermined radial direction position so as to extend in the axial direction. The piston 34 is shaped such that a site thereof on the radial direction outer side of the tubular extending portion 34a is offset to the axial first direction A1 side from a site thereof on the radial direction inner side.

Here, the site of the piston 34 on the radial direction outer side of the tubular extending portion 34a serves as a contact pressing portion 34b that is provided to be capable of pressing the friction members 33 when in contact with the friction members 33. The contact pressing portion 34b is provided between the attachment portion 32c of the tubular connecting member 32 and the friction members 33 in the axial direction so as to overlap these components from the axial direction.

Seal members such as O rings are disposed respectively between the tubular extending portion 32d of the tubular connecting member 32 and the tubular extending portion 34a of the piston 34 and between the tubular projecting portion 32e and a radial direction inner side end portion of the piston 34. As a result, the working oil pressure chamber H1 is formed as an airtight space defined by the radial direction extending portion 32b, the tubular extending portion 32d, the tubular projecting portion 32e, and the piston 34. In this example in particular, the working oil pressure chamber H1 is formed between the radial direction extending portion 32b and a site of the piston 34 on the radial direction inner side of the tubular extending portion 34a. In this embodiment, the working oil pressure chamber H1 is formed on the radial direction inner side of the friction members 33 in a position that partially overlaps the friction members 33. Working oil is supplied from the piston 34 to the working oil pressure chamber H1 through the first oil passage (not shown).

A plate spring 35 is disposed on the radial direction inner side of the axial direction extending portion 32a and the radial direction outer side of the working oil pressure chamber H1. The plate spring 35 biases the piston 34 in the axial second direction A2, i.e. the pressing direction, irrespective of a working oil pressure supplied to the working oil pressure chamber H1. More specifically, in this example, the plate spring 35 is disposed between the attachment portion 32c formed integrally with the radial direction extending portion 32b of the tubular connecting member 32 and the piston 34 so as to bias the piston 34 in the axial second direction A2 while being supported by a reactive force from the attachment portion 32c.

The circulation oil pressure chamber H2 is formed on an opposite side (here, the axial second direction A2 side) of the piston 34 to the working oil pressure chamber H1. The circulation oil pressure chamber H2 is formed as a space defined mainly by the piston 34, the axial direction extending portion 32a, the cover portion 42 of the torque converter TC, the tubular projecting portion 11, the input shaft I, and the clutch hub 31. In this embodiment, seal members respectively seal between the tubular projecting portion 11 and the input shaft I and between the axial direction extending portion 32a and the cover portion 42. As a result, the circulation oil pressure chamber H2 is formed as an airtight space. An oil pressure discharged by the oil pump 9 and regulated to a predetermined oil pressure level by an oil pressure control device (not shown) is supplied to the circulation oil pressure chamber H2 through the second oil passage L2. Further, the oil in the circulation oil pressure chamber H2 is discharged from the third oil passage L3 via a connecting oil passage formed inside the input shaft I.
2-4. Torque Converter

As shown in FIG. 2, the torque converter TC is disposed on the axial second direction A2 side of the rotating electrical machine MG and the input clutch C1 and on the axial first direction A1 side of the intermediate support wall 6 and the speed change mechanism TM. The torque converter TC includes the pump impeller 41, the turbine runner 45, the stator 48, and the cover portion 42 housing these components.

The cover portion 42 is constituted to rotate integrally with the pump impeller 41. Here, the pump impeller 41 is provided integrally on an inner side of the cover portion 42. Further, the cover portion 42 is coupled to the tubular connecting member 32. The cover portion 42 is drive-coupled to the rotor Ro of the rotating electrical machine MG so as to rotate integrally therewith via the tubular connecting portion 32 and the rotor supporting member 22. Hence, the integrally rotating pump impeller 41 and cover portion 42 together constitute an input side rotary member (joint input side member) of the torque converter TC to which the rotation and torque of one or both of the internal combustion engine E and the rotating electrical machine MG are transmitted. In this embodiment, the cover portion 42 corresponds to a “joint rotary member” of the present invention. Further, the cover portion 42 is coupled to the pump drive shaft 43. The cover portion 42 is drive-coupled to the pump rotor of the oil pump 9 so as to rotate integrally therewith via the pump drive shaft 43.

The turbine runner 45 is disposed on the axial first direction A1 side of the pump impeller 41 so as to face the pump impeller 41. The turbine runner 45 forms a pair with the pump impeller 41 to constitute an output side rotary member (joint output side member) of the torque converter TC for transmitting to the intermediate shaft Mon the output shaft O side the rotation and torque input into the pump impeller 41. The turbine runner 45 includes a radial direction extending portion 46 extending in the radial direction. In this embodiment, the radial direction extending portion 46 is spline-coupled to the intermediate shaft M, which is disposed so as to penetrate the radial direction extending portion 46. Further, the stator 48 is disposed between the pump impeller 41 and the turbine runner 45 in the axial direction. The stator 48 is supported on the intermediate support wall 6 via a one way clutch 49 and a fixed shaft.

In this embodiment, a main body portion of the torque converter TC is constituted by the pump impeller 41 and the turbine runner 45 disposed opposite each other. The cover portion 42 that holds the pump impeller 41 from the outer side is disposed so that the turbine runner 45 is also housed therein. In other words, the cover portion 42 is disposed to house the main body portion of the torque converter TC. Furthermore, in this embodiment, the lockup clutch C2 and so on disposed on the axial first direction A1 side relative to the main body portion of the torque converter TC are also housed in the cover portion 42.
2-5. Power Transmission Member

The power transmission member T is a member for transmitting the power (torque) of the rotating electrical machine MG to the speed change mechanism TM on the vehicle wheel W side. In this embodiment, when the rotation and torque of the rotating electrical machine MG are transmitted to the pump impeller 41 of the torque converter TC, the rotation and torque are transmitted to the speed change mechanism TM via the torque converter TC. For this purpose, the power transmission member T is coupled to the rotor supporting member 22 of the rotating electrical machine MG and the pump impeller 41 so as to rotate integrally therewith. The power transmission member T according to this embodiment is formed by integrally coupling the tubular connecting member 32 serving as the output side rotary member of the input clutch C1 and the cover portion 42 of the torque converter TC. Note that when the input clutch C1 is engaged, the power transmission member T is capable of transmitting to the vehicle wheel W side the power (torque) of both the internal combustion engine E and the rotating electrical machine MG

The rotor supporting member 22 and the power transmission member T are coupled by a first fixed fastening portion F1. The first fixed fastening portion F1 is a site for fixedly fastening the rotor supporting member 22 to the tubular connecting member 32. In this embodiment, the radial direction extending portion 24 of the rotor supporting member 22 and the attachment portion 32c of the tubular connecting member 32 are disposed to contact each other in the axial direction. In this example, the attachment portion 32c is disposed to contact the radial direction extending portion 24 from the axial second direction A2 side. These components are disposed such that respective axial centers of the plurality of first bolt insertion holes 24a provided in the radial direction extending portion 24 are perfectly aligned with axial centers of the plurality of first bolt fastening holes provided in the attachment portion 32c. The first bolts 71 are inserted into the respective first bolt insertion holes 24a and fastened to the first bolt fastening holes. As a result, the radial direction extending portion 24 and the attachment portion 32c are fastened to each other fixedly by the first bolts 71, and thus the first fixed fastening portion F1 is formed by the fastening site between the radial direction extending portion 24 and the attachment portion 32c. In this embodiment, the first fixed fastening portion F1 corresponds to a “fixed fastening portion” of the present invention. Note that in this example, the first bolts 71, first bolt insertion holes 24a, and first bolt fastening holes are distributed in the circumferential direction to form a plurality of groups disposed at equal circumferential direction position intervals. Therefore, the “first fixed fastening portion F1” is used as an inclusive term for this plurality of groups.

Note that in this embodiment, the outer peripheral surface of the supporting cylindrical portion 25 and the inner peripheral surface of the tubular extending portion 32d are fitted to each other so as to contact each other over the entirety of the circumferential direction. This determines mutual positioning between the rotor supporting member 22 and tubular connecting member 32 in the radial direction.

The tubular connecting member 32 and the cover portion 42 constituting the power transmission member T are coupled by a second fixed fastening portion F2. The second fixed fastening portion F2 is a site for fixedly fastening the tubular connecting member 32 to the cover portion 42. In this embodiment, the radial direction extending portion 32f of the tubular connecting member 32 and a site of the cover portion 42 that extends in the radial direction are fastened to each other fixedly by a second bolt 72. Thus, the second fixed fastening portion F2 is formed by the fastening site between the radial direction extending portion 32f and the cover portion 42.

As shown in FIG. 2 and so on, on the axial first direction A1 side, the integrally rotating rotor supporting member 22 and power transmission member T (in other words, the integrally rotating rotor supporting member 22, tubular connecting member 32, and cover portion 42) are supported in the radial direction on an outer peripheral surface of the tubular projecting portion 11 formed integrally with the end portion support wall 5 to be capable of rotating via the first bearing 61. A bearing capable of receiving a comparatively large radial direction load is used as the first bearing 61, and in this example, a ball bearing is used. In this embodiment, the first bearing 61 corresponds to a “support bearing” of the present invention. Meanwhile, on the axial second direction A2 side, the integrally rotating rotor supporting member 22 and power transmission member T are supported in the radial direction on an inner peripheral surface of a through hole in the intermediate support wall 6 to be capable of rotating via a second bearing 62. A bearing capable of receiving a radial direction load is used as the second bearing 62, and in this example a needle bearing is used.

Further, the input shaft I disposed to penetrate the tubular projecting portion 11 of the end portion support wall 5 is supported in the radial direction on the inner peripheral surface of the tubular projecting portion 11 to be capable of rotating via a third bearing 63. A bearing capable of receiving a radial direction load is used as the third bearing 63, and in this example a needle bearing is used. In this embodiment, the input shaft I is supported on the inner peripheral surface of the tubular projecting portion 11 via two third bearings 63 disposed along the inner peripheral surface of the tubular projecting portion 11 at intervals of a predetermined distance in the axial direction.

### 3. Arrangement and Structure of Rotation Sensor

Next, the arrangement and structure of the rotation sensor 13 according to this embodiment will be described. In this embodiment, the rotation sensor 13 is basically disposed between the end portion support wall 5 and the tubular projecting portion 11 formed integrally therewith, and the rotor supporting member 22. This will now be described in detail.

As shown in FIGS. 3 and 4, in this embodiment, an axial direction first step portion 11b is provided in a predetermined axial direction position on the outer peripheral surface of the tubular projecting portion 11. Here, the “axial direction step portion” on the outer peripheral surface is a part formed in a predetermined axial direction position of the tubular projecting portion 11 where an outer diameter of the tubular projecting portion 11 varies. The outer peripheral surface of the tubular projecting portion 11 is divided about the first step portion 11b into a large diameter portion on the axial first direction A1 side of the first step portion 11b and a small diameter portion on the axial second direction A2 side of the first step portion 11b. In this example, the first bearing 61 is disposed to contact the outer peripheral surface of the small diameter portion. Note that the first step portion 11b is formed in an axial direction position slightly to the axial first direction A1 side of an inner peripheral step portion 25a of the supporting cylindrical portion 25, to be described below.

As shown in FIG. 3, a second step portion 11c is provided on the outer peripheral surface of the tubular projecting portion 11 in a predetermined position on the axial second direction A2 side of the first step portion 11b. The outer peripheral surface of the tubular projecting portion 11 is divided about the second step portion 11c such that on the axial second direction A2 side of the second step portion 11c, the diameter of the outer peripheral surface is even smaller. The sleeve 56 is fitted to this axial second direction A2 side end portion of the tubular projecting portion 11, which is formed with an even smaller diameter than the small diameter portion, so as to contact the outer peripheral surface thereof. An outer diameter of the sleeve 56 matches the outer diameter of the small diameter portion of the tubular projecting portion 11. Further, the tubular projecting portion 32e of the tubular connecting member 32 is disposed to face the outer peripheral surface of the sleeve 56 in the radial direction.

Furthermore, the rotor supporting member 22 is supported rotatably in the radial direction on the radial direction outer side of the tubular projecting portion 11 via the first bearing 61. In this embodiment, the rotor holding portion 23 and supporting cylindrical portion 25 constituting the rotor supporting member 22 both extend to the axial first direction A1 side relative to at least the radial direction extending portion 24. A pocket-shaped space that opens onto the axial first direction A1 side is defined by the rotor holding portion 23, the radial direction extending portion 24, and the supporting cylindrical portion 25, and the rotation sensor 13 is disposed in this pocket-shaped space. More specifically, the rotation sensor 13 is disposed on the axial first direction A1 side of the radial direction extending portion 24 in a position that partially overlaps the rotor holding portion 23 and the supporting cylindrical portion 25 when viewed from the radial direction. In this embodiment, the tubular connecting member 32 forming the power transmission member T is disposed on the axial second direction A2 side of the rotor supporting member 22, and therefore the rotation sensor 13 is disposed on the opposite side of the rotor supporting member 22 (here, mainly the radial direction extending portion 24) to the power transmission member T in the axial direction.

In this embodiment, as shown in FIG. 4, the supporting cylindrical portion 25 includes a first tubular portion 26 and a second tubular portion 27, which are formed integrally. The second tubular portion 27 is formed such that both an inner peripheral surface and an outer peripheral surface thereof have a smaller diameter than the first tubular portion 26, and disposed on the axial first direction A1 side of the first tubular portion 26. In this example, the inner peripheral step portion 25a is provided in a predetermined axial direction position on the inner peripheral surface of the supporting cylindrical portion 25. A second inner peripheral surface 27a on the axial first direction A1 side of the inner peripheral step portion 25a is formed with a smaller diameter than a first inner peripheral surface 26a on the axial second direction A2 side of the inner peripheral step portion 25a. The first bearing 61 is disposed to contact the first inner peripheral surface 26a and a side face of the inner peripheral step portion 26a on the axial second direction A2 side. Note that in this embodiment, the inner peripheral step portion 25a is formed on the axial first direction A1 side of the radial direction extending portion 24. Further, the first bearing 61 is disposed in a position that partially overlaps the radial direction extending portion 24 when viewed from the radial direction.

An outer peripheral step portion 25b is provided on the outer peripheral surface of the supporting cylindrical portion 25 in a predetermined position on the axial first direction A1 side of the radial direction extending portion 24. A second outer peripheral surface 27b on the axial first direction A1 side of the outer peripheral step portion 25b is formed with a smaller diameter than a first outer peripheral surface 26b on the axial second direction A2 side of the outer peripheral step portion 25b. Note that the outer peripheral step portion 25b is provided on the axial first direction A1 side of the inner peripheral step portion 25a. Hence, in this embodiment, a tubular part of the supporting cylindrical portion 25 on the axial second direction A2 side of the inner peripheral step portion 25a constitutes the first tubular portion 26, and a tubular part on the axial first direction A1 side of the outer peripheral step portion 25b constitutes the second tubular portion 27. In this embodiment, the first tubular portion 26 and the second tubular portion 27 are formed such that an inner diameter of the first tubular portion 26 is substantially equal to an outer diameter of the second tubular portion 27. Further, a connecting portion between the first tubular portion 26 and the second tubular portion 27, which is formed to have a substantially equal outer diameter to the first tubular portion 26 and a substantially equal inner diameter to the second tubular portion 27, is provided between the outer peripheral step portion 25b and the inner peripheral step portion 25a in the axial direction.

In this embodiment, a sensor rotor 14 of the rotation sensor 13 is disposed on the radial direction outer side of the second tubular portion 27. The sensor rotor 14 is attached so as to contact the outer peripheral surface (the second outer peripheral surface 27b) of the second tubular portion 27 and a side face of the outer peripheral step portion 25b on the axial first direction A1 side. The sensor rotor 14 is supported so as to be sandwiched between the outer peripheral step portion 25b and a holding member externally inserted into the second tubular portion 27 from the axial first direction A1 side, while an inner peripheral surface thereof is fitted to the second tubular portion 27. A sensor stator 15 is disposed on the radial direction outer side of the sensor rotor 14 so as to oppose the sensor rotor 14 via a minute gap in the radial direction.

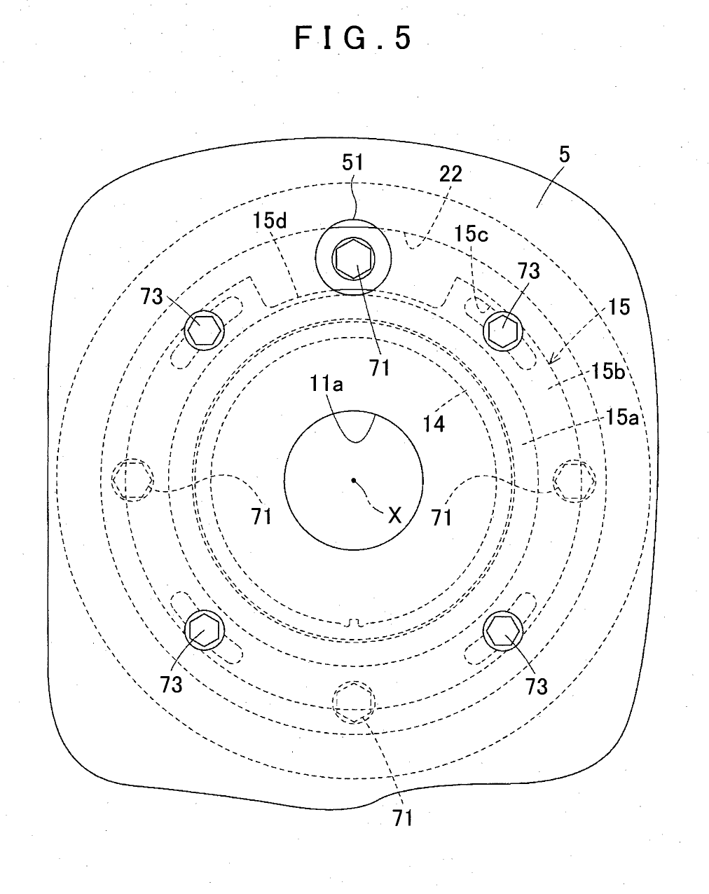

Hence, in this embodiment, the first bearing 61 for supporting the rotor supporting member 22 rotatably is disposed in contact with the first inner peripheral surface 26a having a larger diameter than the second inner peripheral surface 27a, and therefore the rotor supporting member 22 can be supported with a high degree of precision to be capable of rotating appropriately using the comparatively large first bearing 61. Further, the sensor rotor 14 is disposed in contact with the second outer peripheral surface 27b having a smaller diameter than the first outer peripheral surface 26b, and therefore the size of the sensor rotor 14 can be reduced, enabling a reduction in the size of the sensor stator 15. As a result, the entire rotation sensor 13 can be disposed compactly in a limited space while maintaining the precision with which the rotor Ro of the rotating electrical machine MG is supported at a high level. In particular, a main body portion 15a (see FIGS. 4 and 5) of the sensor stator 15 can be disposed within a range on the radial direction inner side of the radial direction position in which the plurality of first bolts 71 are disposed. Note that the main body portion 15a is disposed opposite the sensor rotor 14 in the radial direction in order to detect the rotation position of the sensor rotor 14.

Further, as shown in FIG. 4 and so on, the sensor stator 15 is attached to the end portion support wall 5 of the case 3. In this embodiment, the end portion support wall 5 is provided with a sensor stator attachment portion 52. The sensor stator attachment portion 52 is formed integrally with the end portion support wall 5 so as to protrude to the axial second direction A2 side from the end portion support wall 5. The sensor stator 15 is fastened fixedly to the sensor stator attachment portion 52 by a third bolt 73. In this embodiment, the sensor stator 15 includes an attachment flange portion 15b formed integrally with the main body portion 15a. The attachment flange portion 15b is an annular plate-shaped member formed to extend to the radial direction outer side relative to the main body portion 15a. A planar shape of the rotation sensor 13 is shown clearly in FIG. 5. Note that FIG. 5 is an axial direction view showing the end portion support wall 5 from the axial first direction A1 side, in which the rotation sensor 13 and the first bolts 71 disposed on the axial second direction A2 side of the end portion support wall 5 are indicated transparently by broken lines.

As shown in FIG. 5, an attachment adjustment portion 15c and a cutout portion 15d are provided in the attachment flange portion 15b of the sensor stator 15. The attachment adjustment portion 15c is a hole having an elongated arc shape when seen from the axial direction, and is provided to penetrate the attachment flange portion 15b in the axial direction. The third bolt 73 penetrates a bolt insertion hole in the sensor stator attachment portion 52 and the attachment adjustment portion 15c from the axial first direction A1 side to the axial second direction A2 side, and a nut is fastened to an axial second direction A2 side end portion thereof. As a result, the sensor stator 15 is fastened fixedly to the sensor stator attachment portion 52. At this time, since the attachment adjustment portion 15c is constituted by an arc-shaped elongated hole, a circumferential direction position of the sensor stator 15 can be adjusted.

As shown in FIGS. 4, 5, and so on, in this embodiment, the end portion support wall 5 of the case 3 is provided with a tool insertion hole 51 into which a tool for operating the first bolts 71 from the axial first direction A1 side of the end portion support wall 5 can be inserted. The tool insertion hole 51 is an axial direction through hole having a sufficient inner diameter for inserting a socket wrench, a hexagonal wrench, or the like for tightening and loosening the first bolts 71. At least one tool insertion hole 51 is provided in the end portion support wall 5 in a radial direction position corresponding to the first fixed fastening portion F1. In other words, at least one tool insertion hole 51 is provided on a circumference where the end portion support wall 5 intersects an imaginary cylindrical surface through which the axial centers of all of the plurality of first bolts 71 in the first fixed fastening portion F1 pass. In this embodiment, only one tool insertion hole 51 is provided on an uppermost portion of the aforementioned circumference in an identical radial direction position to the first bolts 71. In other words, of the radial direction positions corresponding to the first bolts 71, a single tool insertion hole 51 is provided in a vertical direction uppermost portion.

The sensor stator 15 is provided so as to avoid the tool insertion hole 51 when fixed to the end portion support wall 5. In this embodiment, the sensor stator 15 includes a single cutout portion 15d in a predetermined position of the attachment flange portion 15b. The cutout portion 15d is formed by cutting away a circumferential direction part of the attachment flange portion 15b so that the sensor stator 15 avoids the tool insertion hole 51 when fixed to the end portion support wall 5. In this example, the cutout portion 15d is formed in an arc-shaped strip form having a constant radial direction width and a constant circumferential direction width. The circumferential direction width of the cutout portion 15d may be set to be larger than an adjustable width of the attachment adjustment portion 15c.

The sensor stator 15 is fastened fixedly to the sensor stator attachment portion 52 in a state where the cutout portion 15d partially overlaps the tool insertion hole 51 when viewed from the axial direction. In other words, most part of the sensor stator 15 is provided in a position not overlapping the tool insertion hole 51 when viewed from the axial direction. Thus, the first bolts 71 and the sensor stator 15 can be disposed in a positional relationship that does not include an overlapping part when viewed from the axial direction. Further, in this embodiment, the sensor stator attachment portion 52 is formed in a different circumferential direction position from that of the tool insertion hole 51. Accordingly, the sensor stator 15 and the sensor stator attachment portion 52 are disposed so as to avoid the tool insertion hole 51 provided in a radial direction position corresponding to the first fixed fastening portion F1. As a result, the tool can be inserted through the tool insertion hole 51 without interfering with the sensor stator 15 and the sensor stator attachment portion 52, and can therefore operate the first bolts 71 appropriately.

Note that by adjusting a rotation position of the rotor supporting member 22 such that the position of the first fixed fastening portion F1 aligns with the position of the tool insertion hole 51 in the end portion support wall 5, a head portion of the first bolt 71 can be operated through the tool insertion hole 51. As a result, the tool can be inserted toward the first fixed fastening portion F1 between the rotor supporting member 22 disposed on the axial second direction A2 side of the end portion support wall 5 and the power transmission member T (in this example, the integrally rotating tubular connecting member 32 and the cover portion 42) from the axial first direction A1 side of the end portion support wall 5 in order to tighten and loosen the first bolts 71. This operation can be performed in sequence on each of the plurality of first bolts 71 (four in the illustrated example) disposed at equal circumferential direction intervals while adjusting the rotation position of the rotor supporting member 22. Hence, with the driving apparatus 1 according to this embodiment, assembly and maintenance can be performed easily.

### 4. Other Embodiments

Finally, other embodiments of the vehicle driving apparatus according to the present invention will be described. Note that the respective constitutions of the embodiments to be described below are not limited to application in the form of the corresponding embodiment, and as long as contradictions do not arise, these constitutions may be applied in combination with constitutions of other embodiments.
(1) In the above embodiment, a case in which the sensor stator 15 includes the cutout portion 15d in a predetermined position of the attachment flange portion 15b and can therefore be provided so as to avoid the tool insertion hole 51 when fixed to the end portion support wall 5 was described as an example. However, the present invention is not limited to this embodiment, and in another embodiment of the present invention, the entire sensor stator 15, including the attachment flange portion 15b, may be reduced in diameter, for example, so that when the sensor stator 15 is fixed to the end portion support wall 5, the entire sensor stator 15 does not overlap the tool insertion hole 51 when viewed from the axial direction.
(2) In the above embodiment, a case in which the tool insertion hole 51 is provided singly in the vertical direction uppermost portion of the radial direction positions corresponding to the first fixed fastening portion F1 and the first bolts 71 was described as an example. However, the present invention is not limited to this embodiment, and as long as the tool insertion hole 51 is provided in a radial direction position corresponding at least to the first fixed fastening portion F1 and the first bolts 71, the vertical direction position thereof may be set arbitrarily, In another embodiment of the present invention, the tool insertion hole 51 may be provided in a plurality in radial direction positions corresponding to the first fixed fastening portion F1 and the first bolts 71. In this case, the plurality of tool insertion holes 51 may be distributed at equal intervals in the circumferential direction. Furthermore, the position, size, range, and so on of the cutout portion 15d formed in the sensor stator 15 may be set in accordance with the arrangement of the plurality of tool insertion holes 51, and at this time, the cutout portion 15d may be provided in a plurality.
(3) In the above embodiment, a case in which the first tubular portion 26 and second tubular portion 27 of the supporting cylindrical portion 25 are formed such that the inner diameter of the first tubular portion 26 and the outer diameter of the second tubular portion 27 are substantially equal was described as an example. However, the present invention is not limited to this embodiment, and as long as at least both the inner peripheral surface and the outer peripheral surface of the second tubular portion 27 are respectively formed to be smaller than the inner peripheral surface and the outer peripheral surface of the first tubular portion 26, the magnitude relationship between the inner diameter of the first tubular portion 26 and the outer diameter of the second tubular portion 27 may be set arbitrarily. In relation to this point, a difference between the outer diameter of the first tubular portion 26 and the outer diameter of the second tubular portion 27, or in other words a height of the outer peripheral step portion 25b, may also be set as desired. At this time, the height of the outer peripheral step portion 25b may be set to be as large as possible in response to demand for a reduction in the overall size of the rotation sensor 13, including the sensor rotor 14 disposed to contact the second outer peripheral surface 27b. Note, however, that in order to maintain a performance of the rotation sensor 13 at an appropriate level, the height of the outer peripheral step portion 25b should remain within a range where interference does not occur between the sensor stator 15 and the first tubular portion 26.
(4) In the above embodiment, a case in which both the input clutch C1 and the torque converter TC are provided in the driving apparatus 1 and the power transmission member T is formed by coupling the tubular connecting member 32 of the input clutch C1 and the cover portion 42 of the torque converter TC to each other integrally was described as an example. However, the present invention is not limited to this embodiment, and in another embodiment of the present invention, only the input clutch C1 may be provided in the driving apparatus 1 such that the power transmission member T is formed from the tubular connecting member 32 of the input clutch C1, or only the torque converter TC may be provided in the driving apparatus I such that the power transmission member T is formed from the cover portion 42 of the torque converter TC. In further another embodiment of the present invention, neither the input clutch C1 nor the torque converter TC may be provided in the driving apparatus 1 and the power transmission member T may be formed using a predetermined rotary member that drive-couples the rotor supporting member 22 of the rotating electrical machine MG to the intermediate shaft M.
(5) In the above embodiment, a case in which the input clutch C1 for selectively drive-coupling the internal combustion engine E and the rotating electrical machine MG to each other is constituted by a multiplate wet clutch mechanism was described as an example. However, the present invention is not limited to this embodiment, and in another embodiment of the present invention, the input clutch C1 may be constituted by a dry single plate clutch mechanism or a mesh type clutch mechanism, for example. Further, in the above embodiment, a case in which the torque converter TC including the pump impeller 41, the turbine runner 45, and the stator 48 is used as a fluid coupling capable of transmitting torque via internally charged oil (an example of a fluid) was described as an example. However, the present invention is not limited to this embodiment, and in another embodiment of the present invention, a fluid coupling or the like having the pump impeller 41 and the turbine runner 45 but not including the stator 48, for example, may be used as this type of fluid coupling.
(6) In the above embodiment, a case in which the clutch hub 31 is drive-coupled to the input shaft I so as to rotate integrally therewith and the tubular connecting member 32 constituting the power transmission member T functions as a clutch drum that forms a pair with the clutch hub 31 was described as an example. However, the present invention is not limited thereto, and in another embodiment of the present invention, a clutch drum may be drive-coupled to the input shaft I so as to rotate integrally therewith and a clutch hub that fowls a pair with the clutch drum is drive-coupled to the rotating electrical machine MG or the like so as to rotate integrally therewith, for example.
(7) In the above embodiment, a case in which the driving apparatus 1 has a single shaft structure suitable for installation in an FR (front-engine, rear-wheel drive) vehicle was described as an example. However, the present invention is not limited to this embodiment, and in another embodiment of the present invention, the driving apparatus 1 may be a multi-shaft driving apparatus that includes a counter gear mechanism or the like, for example, in which an axle is disposed on a different axis to the axis center X shared by the input shaft I and the intermediate shaft M. A driving apparatus having this structure is suitable for installation in an FF (front-engine, front-wheel drive) vehicle.
(8) In the above embodiment, a case in which the driving apparatus 1 is a driving apparatus for a hybrid vehicle that includes both the internal combustion engine E and the rotating electrical machine MG as the drive power sources of the vehicle was described as an example. However, the present invention is not limited to this embodiment, and in another embodiment of the present invention, the driving apparatus 1 may be a driving apparatus for an electric vehicle that includes only the rotating electrical machine MG as the drive power source of the vehicle.
(9) As regards other constitutions, the embodiment disclosed in this specification is, on all points, merely an example, and the present invention is not limited to this embodiment. In other words, as long as the constitutions described in the claims and their equivalents are provided, constitutions in which component structures that are not described in the claims are partially modified where appropriate may of course fall within the technical scope of the present invention.

The present invention can be used favorably as a vehicle driving apparatus including a rotating electrical machine that serves as a drive power source of a vehicle, and a rotation sensor that detects a rotation position of a rotor of the rotating electrical machine.

1. A vehicle driving apparatus comprising:
a rotating electrical machine that serves as a drive power source of a vehicle; and
a rotation sensor that detects a rotation position of a rotor of the rotating electrical machine, wherein
the rotating electrical machine includes a rotor supporting member that supports the rotor from a radial direction inner side,
the rotor supporting member includes a cylindrical supporting cylindrical portion that extends in an axial direction,
the supporting cylindrical portion includes a first tubular portion and a second tubular portion, an inner peripheral surface and an outer peripheral surface of the second tubular portion both having a smaller diameter than an inner peripheral surface and an outer peripheral surface of the first tubular portion, and
a support bearing that supports the rotor supporting member rotatably is disposed to contact the inner peripheral surface of the first tubular portion, and a sensor rotor of the rotation sensor is disposed to contact the outer peripheral surface of the second tubular portion.

2. The vehicle driving apparatus according to claim 1, further comprising:
a power transmission member that transmits a power of the rotating electrical machine to a vehicle wheel side; and
a support wall that extends at least in the radial direction on an opposite side of the rotation sensor in the axial direction to the rotor supporting member, wherein
a fixed fastening portion that fastens the rotor supporting member and the power transmission member to each other fixedly using a bolt is provided in a connecting portion between the rotor supporting member and the power transmission member,
at least one tool insertion hole into which a tool for operating the bolt can be inserted is provided in a radial direction position of the support wall corresponding to the fixed fastening portion, and
a sensor stator of the rotation sensor is provided so as to avoid the tool insertion hole when fixed to the support wall.

3. The vehicle driving apparatus according to claim 1, further comprising:
one or both of an engagement device that selectively drive-couples an internal combustion engine serving as a drive power source of the vehicle and the rotating electrical machine to each other and a fluid coupling capable of transmitting a drive power via an internally charged fluid, wherein
the power transmission member for transmitting the power of the rotating electrical machine to the vehicle wheel side is constituted by an engagement rotary member serving as a rotary member included in the engagement device, a joint rotary member serving as a rotary member included in the fluid coupling, or the integrally coupled engagement rotary member and joint rotary member, and
the rotation sensor is disposed on an opposite side of the rotor supporting member to the power transmission member in the axial direction.

4. The vehicle driving apparatus according to claim 2, further comprising:
one or both of an engagement device that selectively drive-couples an internal combustion engine serving as a drive power source of the vehicle and the rotating electrical machine to each other and a fluid coupling capable of transmitting a drive power via an internally charged fluid, wherein
the power transmission member for transmitting the power of the rotating electrical machine to the vehicle wheel side is constituted by an engagement rotary member serving as a rotary member included in the engagement device, a joint rotary member serving as a rotary member included in the fluid coupling, or the integrally coupled engagement rotary member and joint rotary member, and
the rotation sensor is disposed on an opposite side of the rotor supporting member to the power transmission member in the axial direction.
